(19) United States
(12) Patent Application Publication
(10) Pub. No.: US 2023/0132532 A1
(43) Pub. Date: May 4, 2023

(54) FRAMEWORK FOR PRECISE ACTIONS AND INSIGHTS WITHIN A REAL-TIME DATA SCIENCE PLATFORM

(71) Applicant: Nextqore Inc, Reston, VA (US)

(72) Inventor: Suresh Madihally Rangachar, North Potomac, MD (US)

(21) Appl. No.: 17/980,451

(22) Filed: Nov. 3, 2022

Related U.S. Application Data
(60) Provisional application No. 63/275,410, filed on Nov. 3, 2021.

(51) Int. Cl. G06N 5/04; G06N 5/02

(52) U.S. Cl. CPC G06N 5/04; G06N 5/022

(57) ABSTRACT

Systems and methods are described herein for a framework for providing actions and/or insights within a real-time data science platform. First, the system defines a set of data sources to generate a data pipeline, then collects data from the data sources while one or more operations are being performed. The system then configures one or more operational parameters to prepare the data for processing. The system then provides one or more recommended actions and/or insights related to the data based on these operational parameters.

### CROSS REFERENCE TO RELATED APPLICATIONS

This application claims the benefit of U.S. Provisional Application No. 63/275,410, filed on Nov. 3, 2021, the entirety of which is incorporated herein by reference.

### FIELD

The present invention relates generally to business intelligence and analytics, and more particularly, to methods and systems for providing a framework for precise actions and insights within a real-time data science platform.

### BACKGROUND

Within the business world, there are always struggles with keeping costs low, keeping quality high, and ensuring production and services are performed on time or ahead of time. These aspects are becoming increasingly more difficult to manage for a number of reasons. One reason is that technological change occurs at a rapid pace. Another reason is that health, safety, and environmental regulations and compliance requirements have become increasingly stringent in parts of the world, which leads to constraints on one or more of these goals. As a result, data science plays a key role in identifying the sources of such constraints and delivering a number of insights for businesses. Such insights include cost insights, quality insights, and service or delivery-on-time insights. A major need in the industry is for business intelligence and analytics to deliver such insights for the purpose of building and maintaining digital operations.

Not only are such insights valuable, but there is also a significant need for recommendations for precise actions to be taken based on these insights. Insights provided to a customer may function as, for example, early warnings or early alerts about one or more predicted issues, points of failure, increased costs or need for resources, lack of quality, etc. Actions, on the other hand, may be provided to a customer in the form of a notification or alert presenting a recommended action based on one or more insights.

Currently, there are several solutions for defining the use of data. These solutions lack a practical, operational approach to data processing. They also fail to use this data for precise actions and insights for operational tasks to customers or for preventive maintenance procedures.

Previous approaches have employed simulation-based methods that do not make use of the operational data. These approaches are neither useful nor insightful, because the very nature of the real-time data using sensors, images, and/or application programming interfaces (hereinafter “APIs”) within operations is heavily dependent on the specific environment. Solutions with simulations have limitations when applied, and lack efficiency compared to using a method that uses knowledge gained from real operational data.

Thus, there is a need in the field of business intelligence to create new and useful systems and methods for providing a framework for precise actions and insights within a real-time data science platform. It would be desirable to have a data learning mechanism when using operational data to reflect the operational status and behavior of physical objects, e.g., “physical objects” within the context of the Internet of Things (hereinafter “IoT”). The learning ability of this data learning mechanism should enable customers to operate these physical objects better and make corrections to the model built to reflect the characteristics of the physical objects.

### SUMMARY

The systems and methods described herein provide a framework for precise actions and insights within a real-time data science platform. Such systems and methods function to configure the composition of the sources of data, assist with operation of the sources to produce high-quality, usable data. They further function to adapt to the learned insights from that data to make modifications to the source design, so that customers can operate physical objects in a more useful manner.

The systems and methods address the aforementioned issues and deficiencies by applying a framework for providing precise actions and insights, i.e., an applied reasoning and actioning framework. In some embodiments, processing and/or pre-processing of the data may be performed using one or more Artificial Intelligence (hereinafter “AI”) methods or techniques, such as, e.g., Machine Learning (hereinafter “ML”) and/or Deep Learning techniques. Such AI methods or techniques are used to build an AI model for forecasting and prediction of quality, cost, and/or service or deliverability issues and insights thereof.

Furthermore, the systems and methods improve customer operations by making use of real-time data, which is also used to determine the precision of the AI model for these operations. The systems and methods provide recommendations, in the form of precise actions and/or insights, which can include recommendations to adjust the source of the data to reflect an accurate or near-perfect representation of the attributes and behavior of the physical objects in question.

Additionally, the systems and methods provide recommendations of actions and/or insights relating to future designs of similar types, in order to define the system more accurately using all of the operational experience in the learning database from increasing the number of implementations.

### BRIEF DESCRIPTION OF THE DRAWINGS

These drawings and the associated description herein are provided to illustrate specific embodiments of the invention and are not intended to be limiting.

FIG. 1 is a diagram illustrating the structuring of data to provide enriched data as output based on source data input, in accordance with some embodiments.

FIG. 2 is a diagram illustrating the use of a public API to add context, in accordance with some embodiments.

FIG. 3 is a diagram illustrating a decluttering of data samples, in accordance with some embodiments.

FIG. 4 is a diagram illustrating combining derivatives of a source to produce combined values, in accordance with some embodiments.

FIG. 5 is a diagram illustrating the use of adaptive control to check for missing data, in accordance with some embodiments.

FIG. 6 is a diagram illustrating the use of trending, positive, and negative reinforcement to determine asset status, in accordance with some embodiments.

FIG. 7 is a diagram illustrating streaming, storing, alerting, or tagging data for operational use, in accordance with some embodiments.

FIG. 8 is a diagram illustrating debounce logic on actions to allow time for operations, in accordance with some embodiments.

FIG. 9 is a diagram illustrating an exemplary computer that may perform processing in some embodiments.

### DETAILED DESCRIPTION

In this specification, reference is made in detail to specific examples of the systems and methods. Some of the examples or their aspects are illustrated in the drawings.

For clarity in explanation, the systems and methods herein have been described with reference to specific examples, however it should be understood that the systems and methods herein are not limited to the described examples. On the contrary, the systems and methods described herein cover alternatives, modifications, and equivalents as may be included within their respective scopes as defined by any patent claims. The following examples of the systems and methods are set forth without any loss of generality to, and without imposing limitations on, the claimed systems and methods. In the following description, specific details are set forth in order to provide a thorough understanding of the systems and methods. The systems and methods may be practiced without some or all of these specific details. In addition, well known features may not have been described in detail to avoid unnecessarily obscuring the systems and methods.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

The disclosed systems and methods include one or more of the following components:

(1) A data preprocessing and enrichment framework that adds parameters to the data stream contextually. Such parameters can be configured in the definition phase of the source design.

(2) A possible set of external or public data available to bring context to certain elements of data. For example, if the air quality of a location is being analyzed (i.e., Air Quality Index, hereinafter “AQI”), the AQI of that zip code or PIN code is collected to provide an ability to relate to the value and the trend of the AQI for the geographical location.

(3) A public API with parameters similar to or related to the contextually added parameters. For example, if a diesel generator runs for hours and diesel consumption per hour is being used as a parameter, then gathering data related to an ambient temperature reference provides an insight of possibly higher air conditioner load that results in higher diesel consumption at a given time relative to other times, for the same number of operational hours.

(4) A component which functions to produce derivative values from native values, and further functions to generate a time series accumulation of some of the values to present different options for the analyzed data.

(5) When the data samples are analyzed, a component can determine missing data samples in the system and determine discontinuity in data, thereby triggering a more desirable way to define the source of data and providing a better method of sourcing the data.

In some embodiments, the system may also have one or more of the following optional components:

(1) A component for determining the efficiency of various operations, including, e.g., time to repair the hardware and/or other sources for continuous data sourcing.

(2) A component for providing recommendations for predictive actions.

Furthermore in some embodiments, the systems and methods may additionally have one or more of the following optional executable steps:

(1) Providing recommendations on how to run the sources of data designed for a frequency of collection of data and the synchronization logic between various sources of data.

(2) Deriving factors that assist in improving the quality of the data pipeline, as well as factors that make it difficult to build a robust data pipeline, and providing recommendations for actions on both.

(3) Using long-term performance trends to build a physical object, sourcing data from the physical object, and providing a better design and better components to minimize the time and iterations it may take to get to acceptable quality and robustness of the data pipeline.

The disclosed system is unique when compared with other known systems and solutions in that it provides feedback to the design phase and the operations phase using real operational data and the knowledge of the current results. Similarly, the disclosed system is unique when compared with other known solutions in that it provides feedback relevant to the sources producing the data pipeline into correcting the data source design and operationally managing the design. Additionally, it has ways to learn from globally deployed scenarios that are specific to the type of source types that reflect operation of the physical objects.

The disclosed system is also unique in that the overall architecture of the system is different from other known systems. More specifically, in some embodiments, it provides:
(1) a defined building block to design various sources of data;
(2) the use of operational methods to analyze the source for usefulness to achieve an optimal design; and/or
(3) the use of reasoning and/or actioning logic to prepare the data for AI- or ML-based predictive operations.

The present systems and methods are directed to providing a framework for precise actions and/or insights within a real-time data science platform. Such actions and/or insights may be provided due to the employment of ML and or AI models, methods, or techniques. The result is a recommendation engine for perfecting operations and for providing sourcing and structuring of data for improved designs.

The context of the application is as follows:

(a) A number of data sources are defined and used in producing a data pipeline.

(b) Data is collected in the process of running operations. The operations process also collates and consolidates the data in a usable form, although in various embodiments, the source can provide data in structured and/or unstructured data formats.

(c) Various parameters are configured for the data stream to prepare the data for pre-processing in relation to providing precise actions and/or insights.

The system uses (c) above as a key way to determine and perform the functions for providing actions and/or insights. Specifically, it uses the knowledge from the outcomes of the processing functions to determine actions for operational improvements. It also uses the parameters to determine methods to improve the sourcing and structuring of data.

In some embodiments, the data processed may use ML and/or AI techniques to make operational recommendations to improve the design and structure of data sourcing. This may result in, for example:

(a) better mapping of the source - i.e., delivering greater precision, to achieve a better and closer result for the desired objective;

(b) better running of the source - i.e., stable and predictable operation, which involves one or more of data collection definition, frequency synchronization, and/or other quality aspects to make the data pipeline more robust;

(c) use of the knowledge of a type of source in various applications and geographies, and making recommendations for the future definition of the source from a variety of deployments; and

(d) use of performance trends and/or insights for operational alerts and precision actions for operations and maintenance.

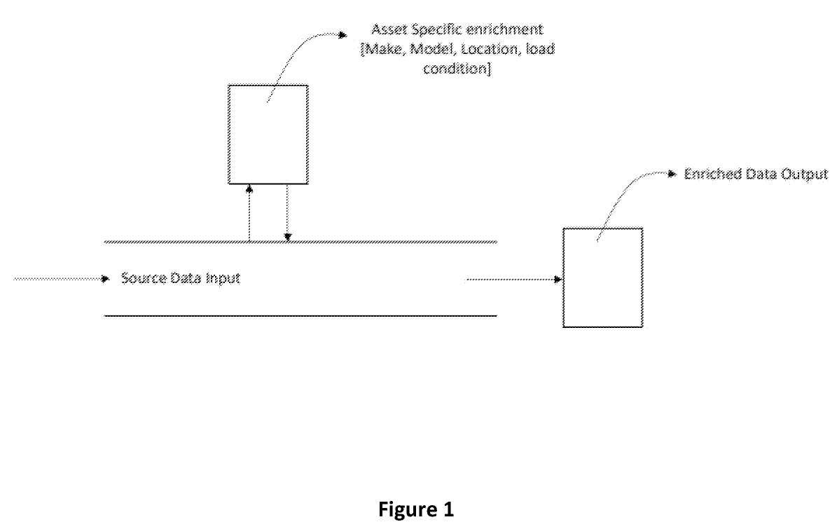

FIG. 1 is a diagram illustrating the structuring of data to provide enriched data as output based on source data input, in accordance with some embodiments.

The illustration shows how, according to some embodiments, the system attaches various enrichment parameters to the data stream so that the data is ready for reasoning with a full context of, e.g., the physical object design, the location where the physical object is placed, and factors that influence the physical object’s performance. Based on a source data input, the source data is structured to provide asset-specific enrichment based on one or more physical object parameters. In various embodiments, such physical object parameters may include one or more of, e.g., the physical object’s make, model, type, location, size, load, variations of load, load condition, variations of load conditions, and more.

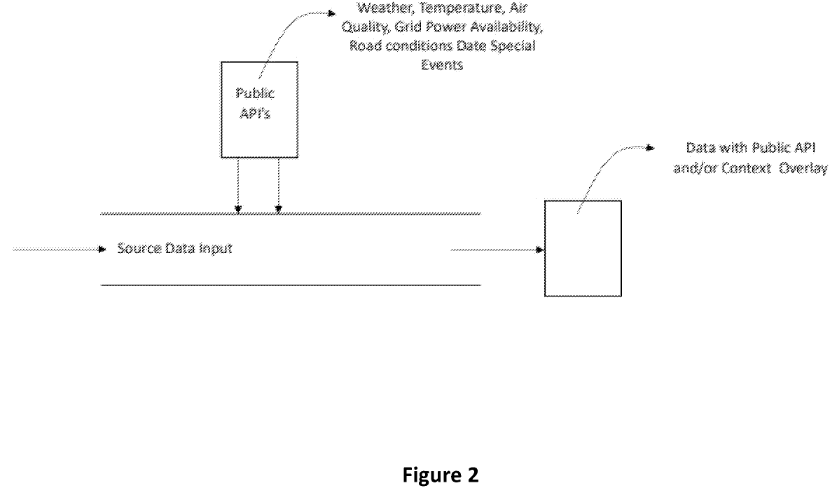

FIG. 2 is a diagram illustrating the use of a public API to add context, in accordance with some embodiments.

As illustrated, many environmental data points overlaid with data can provide a better insight on how to analyze the movement of data relative to the overall parameters that have a bearing on performance. The illustration shows, according to some embodiments, various public APIs the system can use to provide contextual overlays of the data from. Such public APIs may provide macro factors for various operational contexts and situations. Macro factors and related public APIs can include one or more of, e.g., weather, temperature, air quality (i.e., AQI), grid power availability, road conditions, data, special events, or any other suitable factors which can affect operations. Based on a source data input, one or more public APIs containing contextual data on one or more macro factors are used to provide a contextual overlay for that source data. Data from the public API and/or a context overlay for the data is provided as output.

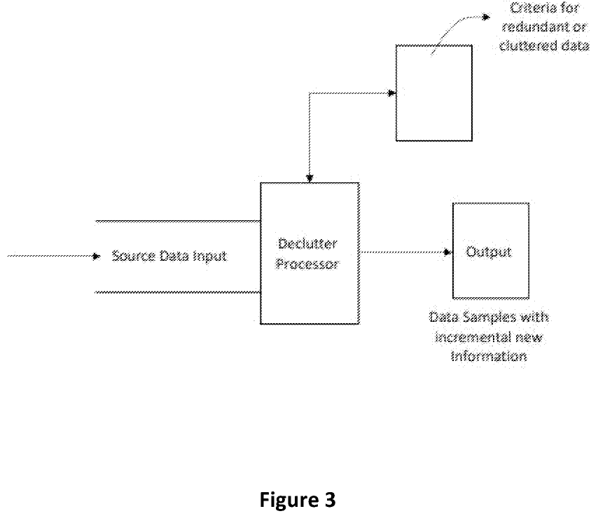

FIG. 3 is a diagram illustrating a decluttering of data samples, in accordance with some embodiments.

The illustration shows how, according to some embodiments, the system uses decluttering techniques to determine a unique set of useful samples from an unstructured sample by eliminating data samples that have no new information. A source data input is fed into a declutter processor, which uses retrieved or prespecified criteria for redundant and/or cluttered data. Data samples with incremental new information are then provided as output.

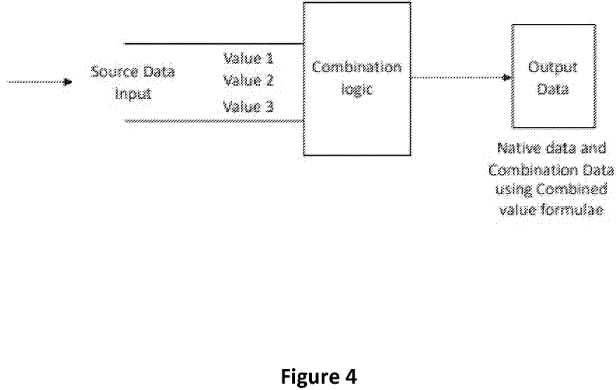

FIG. 4 is a diagram illustrating combining derivatives of a source to produce combined values, in accordance with some embodiments.

The illustration shows how, according to some embodiments, the system performs and derives combined values from native data. The combination values provide the system with an output form with a simpler set of parameters as well as easy correlations. Combined values mean performing a mathematical formula on more than one parameter. Time-series accumulation indicates aggregating a parameter at a specific time interval for an extended duration of time. For example, accumulating the consumption of electricity hourly for the entire day to show consumption for the day forms a time series accumulation. Values from source data input are fed into combination logic. Native data and combination data using combined value formulae are then provided as output data.

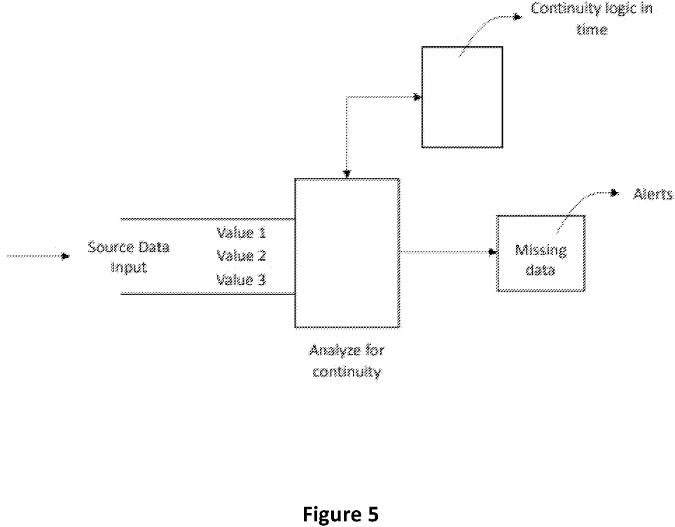

FIG. 5 is a diagram illustrating the use of adaptive control to check for missing data, in accordance with some embodiments.

As shown in the illustration, according to some embodiments, the system checks for missing data samples, and then uses those missing data samples to determine discontinuity in the data sources. It also uses range checks to determine whether the data from the source is above or below a set range to indicate a possible malfunction. A number of values from the source data are received as input, then analyzed for continuity based on prespecified continuity logic in time. Missing data and/or one or more alerts, insights, or recommended actions related to the missing data are then provided.

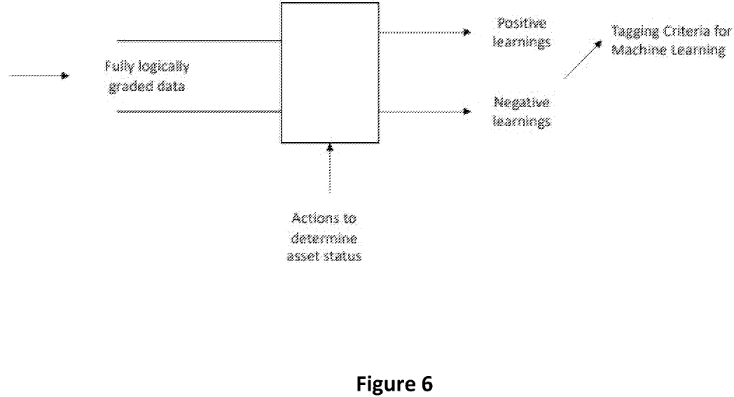

FIG. 6 is a diagram illustrating the use of trending, positive, and negative reinforcement to determine asset status, in accordance with some embodiments.

The illustration shows how, according to some embodiments, the system stores the data for a long-extended period. In some embodiments, the system has the capability to obtain positive and negative confirmations in order to learn a set of criteria. In some embodiments, this criteria is tagged and/or labeled for MI, purposes. The tagged criteria can then be mapped to one or more outcomes. As illustrated, fully logically graded data is received as input, and actions are performed to determine the asset status of the data. Positive and/or negative learning criteria are provided as output, and they are tagged for ML purposes.

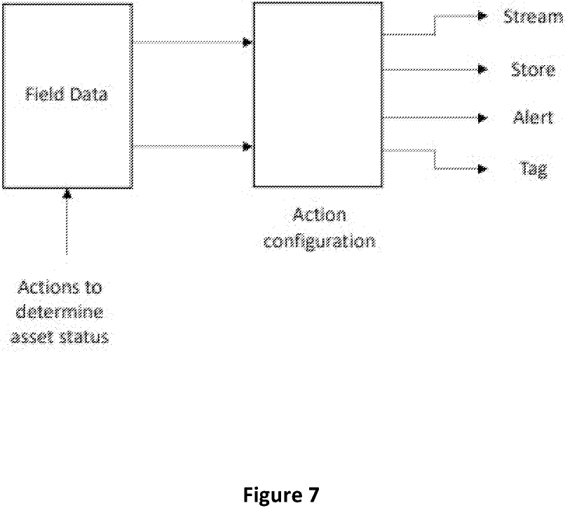

FIG. 7 is a diagram illustrating streaming, storing, alerting, or tagging data for operational use, in accordance with some embodiments.

In some embodiments, after performing the actions to determine asset status from FIG. 6, the system has the capability to perform one or more of the following actions: (1) stream the data to continuously display a dashboard with recommended actions and/or insights; (2) store data for the production of strategic reports; (3) issue an alert or other notification to the designated users on a set of data points that is useful for operations; and/or (4) tag the positive and negative learning criteria, which can then be fed to an ML algorithm for better deployment of ML models.

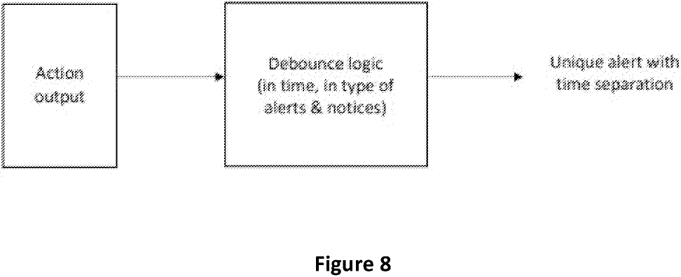

FIG. 8 is a diagram illustrating debounce logic on actions to allow time for operations, in accordance with some embodiments.

In some embodiments, the system is capable of establishing operational metrics regarding how the sources of data are being managed, in order to operate the physical objects based on their determined operational importance. Such operations usually work with an operations service-level agreement (hereinafter “SLA”) of X hours. In some embodiments, the system applies filters, i.e. “debounce logic”, to make sure the same alerts do not get propagated within those X hours, in order to give time for personnel to review and potentially act on the alerts and/or notifications. As illustrated, an action output is received as input, then one or more types of debounce logic are applied, e.g., in time, in type of alerts and notices, etc. A unique alert with time separation is then provided as output.

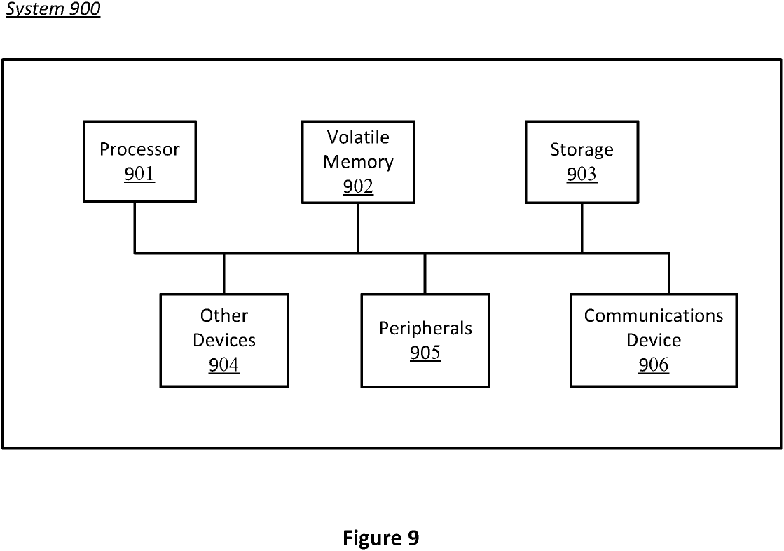

FIG. 9 is a diagram illustrating an exemplary computer that may perform processing in some embodiments. Exemplary computer 900 may perform operations consistent with some embodiments. The architecture of computer 900 is exemplary. Computers can be implemented in a variety of other ways. A wide variety of computers can be used in accordance with the embodiments herein.

Processor 901 may perform computing functions such as running computer programs. The volatile memory 902 may provide temporary storage of data for the processor 901. RAM is one kind of volatile memory. Volatile memory typically requires power to maintain its stored information. Storage 903 provides computer storage for data, instructions, and/or arbitrary information. Non-volatile memory, which can preserve data even when not powered and including disks and flash memory, is an example of storage. Storage 903 may be organized as a file system, database, or in other ways. Data, instructions, and information may be loaded from storage 903 into volatile memory 902 for processing by the processor 901.

The computer 900 may include peripherals 905. Peripherals 905 may include input peripherals such as a keyboard, mouse, trackball, video camera, microphone, and other input devices. Peripherals 905 may also include output devices such as a display. Peripherals 905 may include removable media devices such as CD-R and DVD-R recorders / players. Communications device 906 may connect the computer 900 to an external medium. For example, communications device 906 may take the form of a network adapter that provides communications to a network. A computer 900 may also include a variety of other devices 904. The various components of the computer 900 may be connected by a connection medium 910 such as a bus, crossbar, or network.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to patent claims.

What is claimed:

1. A method for providing actions and/or insights within a real-time data science platform, the method comprising:
defining a plurality of data sources to generate a data pipeline;
collecting data from the plurality of data sources while one or more operations are being performed;
configuring one or more operational parameters to prepare the data for processing; and
providing one or more recommended actions and/or insights related to the data based on the operational parameters.

2. The method of claim 1, further comprising:
upon collecting the data from the plurality of data sources, collating and consolidating the data in a usable form.

3. The method of claim 1, wherein the data collected from the data sources is in a structured format.

4. The method of claim 1, wherein the operational parameters are used to determine one or more functions for providing the one or more recommended actions and/or insights.

5. The method of claim 1, wherein the operational parameters comprise information on outcomes of the operations.

6. The method of claim 1, wherein the operational parameters are used to determine one or more methods to improve the sourcing and structuring of the data.

7. The method of claim 6, wherein the one or more methods to improve the sourcing and structuring of the data comprise one or more of: improved mapping of the source, improved running of the source, improved definition of the source, and improved application of the source.

8. The method of claim 1, wherein the operational parameters are used to determine one or more performance trends related to the data sources.

9. The method of claim 1, wherein providing the one or more recommended actions and/or insights comprises providing one or more operational alerts related to operation or maintenance of the data sources.

10. The method of claim 1, wherein providing the one or more recommended actions and/or insights is performed via one or more artificial intelligence (AI) or machine learning (ML) techniques.

11. A communication system comprising one or more processors configured to perform the operations of:
defining a plurality of data sources to generate a data pipeline;
collecting data from the plurality of data sources while one or more operations are being performed;
configuring one or more operational parameters to prepare the data for processing; and
providing one or more recommended actions and/or insights related to the data based on the operational parameters.

12. The communication system of claim 11, wherein the one or more processors are further configured to perform the operation of:
upon collecting the data from the plurality of data sources, collating and consolidating the data in a usable form.

13. The communication system of claim 11, wherein the data collected from the data sources is in a structured format.

14. The communication system of claim 11, wherein the operational parameters are used to determine one or more functions for providing the one or more recommended actions and/or insights.

15. The communication system of claim 11, wherein the operational parameters comprise information on outcomes of the operations.

16. The communication system of claim 11, wherein the operational parameters are used to determine one or more methods to improve the sourcing and structuring of the data.

17. The communication system of claim 11, wherein the one or more methods to improve the sourcing and structuring of the data comprise one or more of: improved mapping of the source, improved running of the source, improved definition of the source, and improved application of the source.

18. The communication system of claim 11, providing the one or more recommended actions and/or insights comprises providing one or more operational alerts related to operation or maintenance of the data sources.

19. The method of claim 1, wherein providing the one or more recommended actions and/or insights is performed via one or more artificial intelligence (AI) or machine learning (ML) techniques.

20. A non-transitory computer-readable medium comprising:
instructions for defining a plurality of data sources to generate a data pipeline;
instructions for collecting data from the plurality of data sources while one or more operations are being performed;
instructions for configuring one or more operational parameters to prepare the data for processing; and
instructions for providing one or more recommended actions and/or insights related to the data based on the operational parameters.
